(19) United States
(12) Patent Application Publication
(10) Pub. No.: US 2021/0056941 A1
(43) Pub. Date: Feb. 25, 2021

(54) MICROTONAL MUSICAL INSTRUMENT INTERFACE DEVICE

(71) Applicant: Kevin D.Y. Chang, Durham, NC (US)

(72) Inventor: Kevin D.Y. Chang, Durham, NC (US)

(21) Appl. No.: 16/997,220

(22) Filed: Aug. 19, 2020

Related U.S. Application Data
(60) Provisional application No. 62/889,933, filed on Aug. 21, 2019.

(51) Int. Cl. G10H 1/00; G10H 1/34

(52) U.S. Cl. CPC G10H 1/0066; G10H 1/0008; G10H 2210/401; G10H 2220/265; G10H 1/34

(57) ABSTRACT

A microtonal musical instrument interface device between one or more Musical Instrument Digital Interface (MIDI) controllers and one or more musical instruments comprises a housing and a plurality of potentiometers on a surface of the housing. The potentiometers comprise twelve tuning potentiometers constructed and arranged to correspond to notes of a musical scale, each tuning knob for tuning one of the notes; an offset potentiometer for globally tuning all of the notes by a same amount; and a range potentiometer for setting a maximum tuning range of the tuning potentiometers. A microprocessor in the housing modifies a MIDI data stream received from the one or more MIDI controllers for output to the one or more musical instruments according to a position of the potentiometers.

### RELATED APPLICATIONS

This application claims the benefit of U.S. Provisional Patent Application Ser. No. 62/889,933, filed on Aug. 21, 2019, the contents of which is incorporated herein by reference in its entirety.

### FIELD

The present disclosure relates generally to musical instruments, and more specifically, to a microtonal tuning controller between a Musical Instrument Digital Interface (MIDI) controller and a musical instrument.

### BACKGROUND

Microtonal music, or microtonality, pertains to the use in music using notes or the like that fall between the twelve equally-sized intervals of a musical octave.

Conventional methods of experimenting with microtuning electronic musical instruments or the like involve loading a specific tuning, often in the form of a list of frequencies or frequency ratios, and then playing the tuning to hear how it sounds. However, there are limitations with the conventional methods.

When performing conventional tuning methods, the relationship between one tuning and another can be understood numerically and by listening to the difference, which may be large, while toggling between two tuning presets. However, it is more natural for a musician to experience said relationship by listening to the process of retuning without large jumps in tuning and mediated through an interface that correlates retuning with meaningful movements of one's body.

Conventional tuning methods favor viewing tuning as somewhat immutable and are not suited for tuning in real-time, for example, while performing a musical piece. A piano, for instance, is tuned by a skilled technician ahead of a performance and is difficult to retune while performing the musical piece. However, electronic musical instruments are not inherently constrained in that way, and it can be musically advantageous to be able to retune an instrument in real-time.

Conventional methods of tuning favor viewing tuning as something that is imposed on an instrument and not something that can be renegotiated. The spectral content of a timbre produced correlates to the scale tunings that are commonly considered musical for that timbre. For instance, the common scale composed of 12 equally-sized intervals of an octave roughly correlate to the harmonic series, and harmonic timbres (i.e., ones composed of the harmonic series) are the most common timbres. In contrast, electronic musical instruments allow a musician to explore unconventional and sometimes inharmonic timbres. To find a suitable scale tuning for an inharmonic timbre, conventional tuning methods require a rationalistic approach of measuring the spectral content of the timbre and doing mathematical calculations to generate a list of possible frequencies or frequency ratios, all before getting to hear the tuning. However, it is more natural for a musician to approach tuning empirically by using an ear to find a suitable scale tuning for a newly discovered timbre.

### BRIEF SUMMARY

In one aspect, a microtonal musical instrument interface device between one or more Musical Instrument Digital Interface (MIDI) controllers and one or more musical instruments, comprising: a housing; a plurality of potentiometers on a surface of the housing, the potentiometers comprising: twelve tuning potentiometers constructed and arranged to correspond to notes of a musical scale, each tuning knob for tuning one of the notes; an offset potentiometer for globally tuning all of the notes by a same amount; and a range potentiometer for setting a maximum tuning range of the tuning potentiometers; and a microprocessor in the housing that modifies a MIDI data stream received from one or more MIDI controllers for output to one or more musical instruments according to a position of the potentiometers.

In another aspect, a microtonal musical instrument interface device comprises a special-purpose microprocessor that modifies a MIDI data stream received from one or more MIDI controllers for output to one or more musical instruments and The microtonal musical instrument interface device of claim 1, wherein when a MIDI message comprising a note is received on a pre-configured MIDI channel or dedicated hardware input port, the microprocessor replaces the reference note with the received MIDI note and recalculates the tuning array relative to it; and a memory device that stores computer program code, a tuning array or other suitable data structure, and a reference note or frequency, wherein the tuning array comprises numerical tuning values relative to the reference note or frequency and for each and every note to be retuned, wherein the tuning array is used for calculations to generate tuned MIDI output, wherein when a MIDI message comprising a note is received on the pre-configured MIDI channel or dedicated hardware input port, the microprocessor replaces the reference note with the tuned note resulting from the received MIDI note and recalculates the tuning array relative to it.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of a microtonal musical instrument interface device interfacing a Musical Instrument Digital Interface (MIDI) controller and a musical instrument, in accordance with some embodiments of the inventive concepts.

FIG. 1A is a block diagram of a microtonal musical instrument interface device interfacing a plurality of Musical Instrument Digital Interface (MIDI) controllers and a plurality of musical instruments, in accordance with some embodiments of the inventive concepts.

FIG. 2 is a front view of a microtonal musical instrument interface, in accordance with some embodiments of the inventive concepts.

FIG. 3 is a top view of the microtonal musical instrument interface of FIG. 2.

FIG. 4 is a block diagram of the microtonal musical instrument interface of FIGS. 1-3, in accordance with some embodiments of the inventive concepts.

FIG. 5 is a front view of a microtonal musical instrument interface, in accordance with other embodiments of the inventive concepts.

FIG. 6 is a flow diagram of a method of operation of a microtonal musical instrument interface, in accordance with some embodiments of the inventive concepts.

FIG. 6A is a flow diagram of a method of operation of a microtonal musical instrument interface, in accordance with some embodiments of the inventive concepts.

FIG. 7 is a flow diagram of a method for selecting a fundamental algorithm for processing MIDI messages, in accordance with some embodiments of the inventive concepts.

FIG. 8 is a flow diagram of a method for selecting an output port to output MIDI messages, in accordance with some embodiments of the inventive concepts.

### DETAILED DESCRIPTION

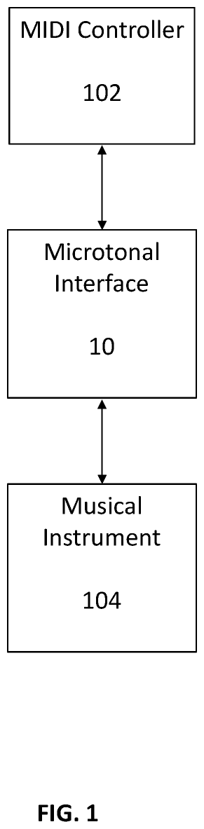

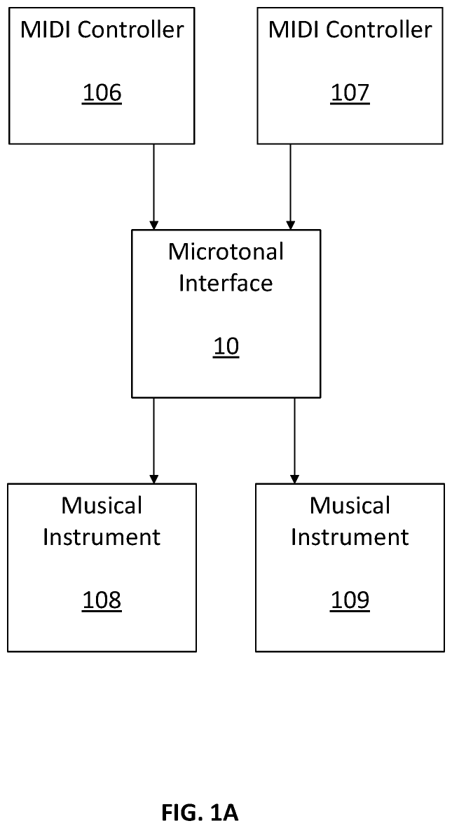

In brief overview, a microtonal musical instrument interface device is described for mapping instrument keys or other tone-producing elements of a musical instrument to microtonal pitches according to the Musical Instrument Digital Interface (MIDI) technical standard, in particular, allow a user to perform tuning of an instrument accordingly to any one of the multiple ways offered by the MIDI standard. As shown in FIG. 1, in some embodiments, microtuning is accomplished by a microtonal musical instrument interface device 10 modifying a data stream, referred to as “tuned MIDI data”, received from a MIDI controller 102 for output to a MIDI instrument 104. Accordingly, the microtonal musical instrument interface device 10 provides an intuitive way to perform and/or experiment with microtonal scales on the MIDI instrument 104. Example MIDI instruments 104 may include but not be limited to electric guitars, keyboards, percussion instruments, and so on. In sone embodiments, the microtonal musical instrument interface device 10 acts as a controller, whereby no MIDI input is required. The physical interface 10 maps keys and microtonal pitches to provide immediate and independent control of pitches in a scale. In contrast to executing microtonality by generating lists of frequencies or ratios, embodiments of the inventive microtonal musical instrument interface device naturally engage the ear of a listener and provides an intuitive way to experiment with microtonal pitches.

As shown in FIG. 1A, in some embodiments, microtuning is accomplished by a microtonal musical instrument interface device 10 modifying a data stream, received from a plurality of MIDI controllers 106, 107 for output to a plurality of MIDI instruments 108, 109. A microtonal musical instrument interface device 10 can receive MIDI simultaneously from up to six MIDI controllers in some embodiments, or more in other embodiments. A microtonal musical instrument interface device 10 can output MIDI simultaneously to up to seven MIDI instruments in some embodiments, or more in other embodiments.

Accordingly, the microtonal musical instrument interface device 10 addresses and overcomes deficiencies of the conventional tuning techniques described above. For example, a user can more easily use their ears to develop a sense of the relationship between different tunings and their hands to feel the tuning process of moving potentiometers 112, 114, 116. A user can change tuning in real-time as part of a performance, for example, during a free jazz performance. Another example is to quickly change keys for a just intonation tuning which is commonly regarded as sounding best in only one key. A user can intuitively use their ears while turning tuning knobs to empirically find a suitable tuning during and/or after modifying the timbre produced by the instrument.

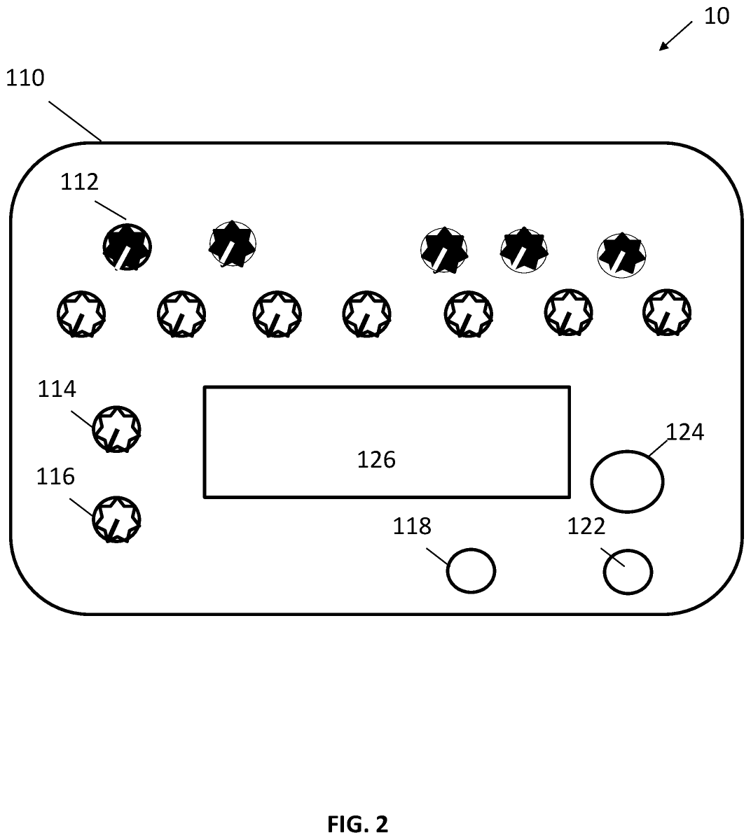

FIG. 2 is a front view of a microtonal musical instrument interface device 10, in accordance with some embodiments of the inventive concepts. As described in FIG. 1, the microtonal musical instrument interface device 10 is constructed and arranged to be connected between a combination of a MIDI controller, a computer, a synthesizer or other musical sound simulator, and a musical instrument. The interface device 10 is constructed and arranged to operate in various modes, such as a twelve tone tuning mode or an Equal Divisions per Octave (EDO) mode, also referred to as a Scala Preset mode. In the Scala Preset mode, the preset files specify tuning details such as parameters or other information according to a Scala file format and are saved on the micro SD card. In this mode, the LCD 126, rotary encoder 124, and buttons 118, 122 are used to browse and load preset tunings. The presets may be saved by a user from the twelve tone tuning mode, or generated in another manner, for example, downloaded from the Internet.

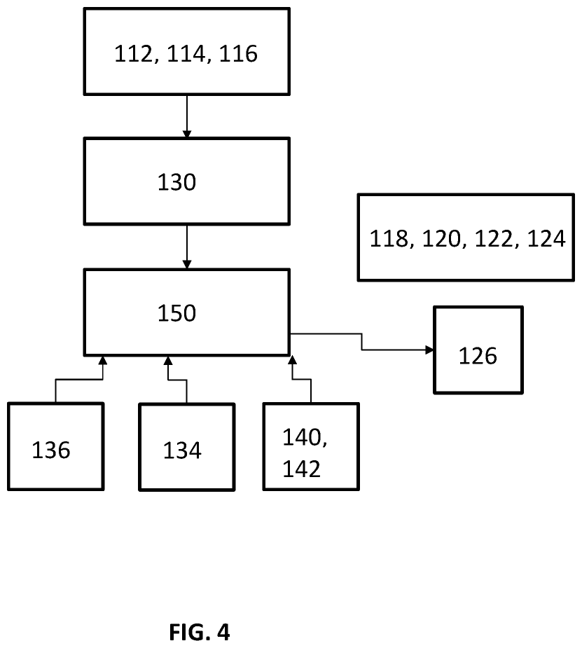

In some embodiments, the microtonal musical instrument interface device 10 includes a set of knobs 112 that operate as tuning potentiometers and are positioned on a housing 110 or other enclosure. In some embodiments, the knobs 112 are linear taper potentiometers. In some embodiments, slide potentiometers are used in lieu of rotary potentiometers. In some embodiments, rotary encoders or membrane potentiometers are used in lieu of rotary potentiometers. The knobs 112 are coupled to electrical circuitry (described herein) including a microprocessor 150 and analog-to-digital converter (ADC) 130 shown in FIG. 4 positioned inside the housing 110. Each knob 112 corresponds to a note of a twelve-tone scale. In some embodiments, the knobs are arranged and color-coordinated to match a conventional piano keyboard layout, e.g., C, C#/Db, D, D#/Eb, E, F, F#/Gb, G, G#Ab, A, A#/Bb, and B keys. For example, the leftmost white knob may tune a C note of a white piano key, the leftmost black knob may tune a C-sharp note of a black piano key, and so on. So, for instance, the C knob tunes every C across every octave. Accordingly, the potentiometers 112 correspond to the notes of a twelve-tone musical scale, e.g., a chromatic scale, across the whole range of MIDI notes (0-127) for every note in the chromatic scale. The tuning is neutral when the knob is at 50%. Turn the knob left to tune flat and right to tune sharp. Other embodiments may include various physical arrangements and layouts of the knobs 112 depending on the instrument to which the interface device 10 communicates. In contrast to the twelve tone tuning mode, conventional methods approach microtuning differently and provide a much less intuitive albeit common way of achieving microtonal scales that involves typing ratios and/or cent values into a text document.

The microtonal musical instrument interface device 10 also includes a global tuning offset knob 114 on the housing 110 includes a potentiometer for tuning all notes, e.g., globally tuning the twelve notes controlled by the tuning potentiometers 112 by a same amount, such as a flat or sharp. For example, turning the offset 114 in a counterclockwise direction provides a flat offset, and turning the offset 114 in a clockwise direction provides a sharp offset. The tuning and global offset potentiometers 112, 114 have a wide neutral zone implemented in the firmware of the apparatus. In some embodiments, experimental data indicates that 6% of the middle readings would be mapped to the neutral zone. Here, the lowest 47% of the readings are in a flat tuning zone and the highest 47% of the readings are in the sharp tuning zone. The remaining 6% of the readings are interpreted as a neutral reading. In some embodiments, the knob 114 is a linear taper potentiometer.

The microtonal musical instrument interface device 10 also includes a range knob 116 on the housing 110 that is constructed and arranged to set a maximum tuning range of the twelve tuning potentiometers 112. The range knob 116 includes a potentiometer for adjusting a range of the tuning potentiometers 112 from 0% to 100%, where 0% refers to a neutral tuning parameter and 100% refers to the tuning potentiometers 112 spanning an entire preconfigured range. In some embodiments, the knob 116 is a linear taper potentiometer. A combination of the global tuning offset knob 114 and range knob 116 can provide global control of the range of the tuning potentiometers 112 (in twelve-tone mode, not EDO mode), which controls the range of all of the tuning potentiometers 112. When the range potentiometer 116 is at 100%, the twelve tuning potentiometers 112 operate at full range giving the widest range of tuning from the most flat to most sharp. When the range potentiometer 116 is at 0%, the 12 tuning knobs are essentially disabled so that the microtonal musical instrument interface device simply passes the standard twelve-tone tuning thru. This is a great feature for performers wanting to quickly revert to the standard twelve-tone tuning. The range potentiometer 116 can be anywhere between 0 and 100%, and then the 12 tuning knobs 112 will have less than the full range available.

The microtonal musical instrument interface device 10 also includes a set of buttons, for example, a “Back” button 118 and “Enter” button 122, for navigating a configuration menu displayed on a display 126. In some embodiments, the display 126 is a liquid crystal display (LCD), for example, a 40×4 character LCD, but not limited thereto. In some embodiments, the LCD 126 displays up to 160 alpha-numeric characters across 4 rows. The LCD screen 126 displays the tuning results corresponding to musical intervals, expressed in relative cents or the like, provided by the tuning potentiometers 112 and/or other tuning information in real-time or near real-time which is helpful for repeating tunings or matching the tuning of other instruments. In some embodiments, the tuning potentiometers 112 are configured to span+/−100 cents, whereby the range of rotation can span 100 cents flat or 100 cents sharp. In the middle position, a potentiometer knob is in a neutral tuning position, and spans a larger range of the potentiometer's physical rotation than each of the other 199 steps of the range. In some embodiments, the LCD screen 126 displays a configuration menu for configuring the absolute ranges of the global offset 114 and tuning potentiometers 112 with note names.

In some embodiments, the microtonal musical instrument interface device 10 also includes a rotary encoder 124 on the housing 110 that can set a pitch bend range used in calculating the cents to display for a twelve-tone (non-EDO) mode. In some embodiments, the pitch bend range is set within a configuration menu, described below. In some embodiments, the rotary encoder 124 is a knob that provides 24 detents per revolution but not limited thereto. The rotary encoder knob 124 can be turned, or otherwise set, to match the pitch bend range of the MIDI instrument to which the interface device 10 is attached. In some embodiments, a Pitch Bend range knob operates as the rotary encoder. The rotary encoder allows setting the pitch bend range used in calculating the cents to display for the twelve-tone (not EDO) mode. It may be set to match the pitch bend range of the MIDI instrument 104. The buttons 118, 122 and rotary encoder 124 are used to navigate the LCD 126 through a configuration menu displayed at the LCD. For example, the buttons 118, 122 can be used to navigate forward and backward through the menu and the rotary encoder 124 can be used to cycle through possible values of a selected menu item.

The following is an embodiment of a configuration and display tree that is executed by a combination of the rotary encoder 124 and buttons 118, 122, a result of which can be displayed at the LCD 126 of FIG. 2.

A root display displays on the LCD 126 the current selected live mode, either 12 Tone or Scala Preset. The 12 Tone mode displays the relative tuning of each note to the nearest cent, also the global tuning amount to the nearest cent and the range to the nearest cent. These tuning values are set with the corresponding potentiometers 112, 114, 116.

The Scala Preset mode displays the currently loaded Scala tuning file with the current reference MIDI note and any text such as a description included in the comment field of the Scala file.

For the root display, the Enter button 122 changes the LCD 126 to show the first level of a menu tree that includes various settings and utilities. The Back button 118 and rotary encoder 124 do not participate in this configuration until the menu tree is displayed.

For displays other than the root display, the Enter button 122 saves the selected value and updates the LCD 126 to display the next display as designated by the menu tree. The Back button 118 cancels changing the selected value and updates the LCD 126 to the previous display. The rotary encoder 124 decrements or increments the selected value.

The first level of the menu tree comprises the following selectable options: Select Operating Mode, Save Tuning as a Scala Preset, Browse Scala Presets, Send MIDI Program Change Messages, Configure DIN1 MIDI Output, Configure DIN2 MIDI Output, Configure USB Device MIDI Output, Configure USB Host MIDI Output, and Global Settings and Utilities.

When a displayed option “Select Operating Mode” is selected, the user is prompted to select between the twelve tone tuning mode and the Scala preset mode. Selecting one of those modes results in the LCD 126 displaying the corresponding root display.

The display “Save Tuning as a Scala Preset” is only available in the menu when in a twelve tone tuning mode. When it is selected, the user is prompted to select and enter a name for the Scala preset file as well as the reference note (C, C#/Db, D, . . . , B) for the tuning operation. After that, a Scala file is generated using the tuning values specified in twelve tone tuning mode with the tuning potentiometers 112 and range potentiometer 116 and then saved on a micro SD card via the memory card port 136. The LCD 126 is updated to the root display of the twelve tone tuning mode.

The “Browse Scala Presets” display is only available in the menu when in Scala Preset mode. When it is selected, the user is shown a file browser to select a tuning from the Scala files that are saved on a micro SD card via the memory card port 136. After selecting a file, the user is prompted to enter the MIDI reference note (0-127 and corresponding note names per the MIDI specification), and then the tuning is loaded for use with the MIDI tuning algorithms. The LCD 126 is updated to the root display of the Scala preset mode.

When the display “Send MIDI Program Changes Mode” is selected, the user is prompted to enter the values specified for a MIDI program change messages: the MSB or Most Significant Byte (0-127), the LSB or Least Significant Byte (0-127), and the Program number (0-127). Then the user is prompted to enter the MIDI output port to use DIN1 142, DIN2 144, USB device 134, USB host 138). After that, a MIDI program change message is generated for every configured channel on the specified port and sent out the port. The LCD 126 is updated to display the first level of the menu tree.

When one of the following displays “Configure DIN1 MIDI Output,” “Configure DIN2 MIDI Output,” “Configure USB Device MIDI Output,” or “Configure USB Host MIDI Output” is selected, the user is prompted to select the following settings specific to the respective output port. The input MIDI channel (0-15 or OFF) is the channel a controller sends MIDI to be processed by the designated MIDI tuning algorithm. “OFF” means that no MIDI messages will be processed for the respective output port. The output MIDI channel (0-15) is the base MIDI channel used to send the tuned MIDI messages. The MIDI mode (pitch bend or MIDI tuning standard) selects which method to use to perform the tuning. If “pitch bend” is selected, then the user is prompted in enter the number of MIDI channels to use (1-16), and, for 1 MIDI channel, which monophonic re-trigger mode to use (low note, high note, or last note). If “MIDI tuning standard” is selected, the user is prompted to select the format (scale per octave real-time, scale per octave non-real-time, single note real-time without a bank, single note real-time, and single note non-real-time) and the bank (0-127) if applicable. After those selections are made, the configuration is saved on a micro SD card via memory card port 136 so that the configuration is available again after powering off and back on. The settings are also used to choose the designated MIDI tuning algorithms that are used. The LCD 126 is updated to display the first level of the menu tree.

When the display “Global Settings and Utilities” is selected, the following options are selectable by the user: Pitch Bend Range, Global Offset Pitch Bend Range, Pitch Bend Tuning Mode, Absolute Retuning MIDI Channel, Relative Retuning MIDI Channel, Pot Calibration, and Mount the Micro SD Card. Whenever one of the global settings are updated, the value is stored on a micro SD card via memory card port 136 to preserve the setting after powering off and on again.

When the display “Pitch Bend Range” is selected, the user is prompted to enter a whole number of semitones (1-12) that corresponds to the range of each of the twelve tuning potentiometers 112, where entering 1 means+/−1 semitone or +/−100 cents, 2 means+/−2 semitones or +/−200 cents, etc. When “Global Offset Pitch Bend Range” is selected, the user is similarly prompted to enter a whole number of semitones (1-12) that correspond to the range of the Global Offset potentiometer 114. When either of the two above pitch bend range values are updated, a MIDI pitch bend range RPN (Registered Parameter Number) message is generated and sent out of all the output ports. That message updates the pitch bend range on the connected musical instruments to the sum of semitones selected (2-24 corresponding to +/−2 semitones to +/−24 semitones) for the “Pitch Bend Range” and the “Global Offset Pitch Bend Range.” 24 semitones is the maximum MIDI pitch bend range, and sending the sum allows for the above two pitch bend ranges to operate independently without bending past the maximum pitch bend range. The LCD 126 is updated to display the “Global Settings and Utilities” selections menu.

When the display “Pitch Bend Tuning Mode” is selected, the user is prompted to select between Real-Time Tuning and Next Note Tuning. “Real-Time Tuning” means any held notes are retuned immediately, and “Next Note Tuning” means the tuning will take effect on the next note that is played. The LCD 126 is updated to display the “Global Settings and Utilities” selections menu.

When the display “Absolute Retuning MIDI Channel” or “Relative Retuning MIDI Channel” is selected, the user is prompted to enter the incoming MIDI channel (0-15). If a MIDI controller sends a MIDI note on one of those channels when operating in Scala Preset mode, a tuning array or other suitable data structure is immediately updated to use a new reference note. In some embodiments, the tuning array is an array, or other suitable data structure, of frequencies, one for every note to be tuned. In some embodiments, the tuning array is an array, or other suitable data structure, of numbers that correlate to frequencies in a way that is useful for generating MIDI tuning messages such as MIDI note and pitch bend values, but not limited thereto. “Absolute” means that the new reference note is set to the fundamental frequency of the MIDI note in the most common twelve equal divisions per octave tuning. “Relative” means that the new reference note is set to the fundamental frequency that the MIDI note maps to applying the tuning array immediately before it is updated. The LCD 126 is updated to display the “Global Settings and Utilities” selections menu.

When the display “Pot Calibration” is selected, the user is instructed to turn every knob fully clockwise and then press enter. Fully clockwise produces the maximum reading of the potentiometers, and the microprocessor 150 samples the maximum readings many times to find the lowest over a short period of time. The lowest maximums are stored in EEPROM for use after powering off and on. The reason for this is that the maximum reading is dependent upon the power supply tolerance and thus varies by a small amount. The minimum reading is always zero. Knowing the maximum reading is required in order to map the readings to the full 14-bit MIDI pitch bend range. The LCD 126 is updated to display the “Global Settings and Utilities” selections menu.

When the display “Mount the Micro SD Card” is selected, the user is instructed to insert a micro SD card into the memory card port 136 and press enter. The micro SD card is then attempted to be mounted for use. The LCD 126 is updated to display if there was an error or if it was mounted successfully, and then the LCD 126 is updated to display the “Global Settings and Utilities” selections menu.

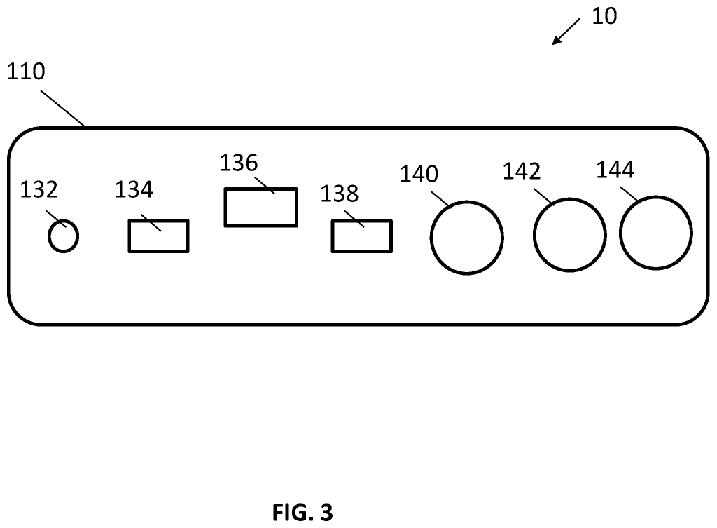

FIG. 3 is a top view of the microtonal musical instrument interface device 10. In some embodiments, positioned on a top surface of the housing 110 or related enclosure includes a power button 132, Universal Serial Bus (USB) device port 134, memory card such as a micro Secure Digital (SD) card port 136, USB host port 138, serial MIDI Deutsches Institut für Normung (DIN) input port 140, a serial MIDI DIN output port 142, and a second DIN output 144, but not limited thereto. In other embodiments, some or all of the a power button 132, USB device port 134, micro SD port 136, USB host port 138, serial MIDI DIN input port 140, serial MIDI DIN output port 142, and second DIN output 144 are positioned on surfaces of the housing 110 other than the top surface, for example, on a same surface as some or all of the buttons, knobs, etc. shown and described with respect to FIG. 3.

In other embodiments, the device 10 may include input/output ports, connectors, or the like alternative to MIDI over DIN or USB, such as MIDI input/output over Bluetooth LE, RTP, and/or Firewire, and so on, but not limited thereto.

The power button 132 is coupled to a power supply in the housing 110 for powering the power supply on and off. The power supply in turn provides sufficient voltage, current, or the like to the various electronic components described in FIGS. 2 and 3.

The USB device port 134 is constructed and arranged to exchange data with a computer-based device, e.g., a host device, via a compatible cable or wireless connection, for example, MIDI device such as a personal computer, controller, keyboard, and so on running programs that provide various MIDI functions. A personal computer can run software that functions as a MIDI musical instrument or other MIDI device that would send and receive MIDI over the USB device port 134. In some embodiments, the USB device port 134 is a micro-USB port or the like that in part supplies power from an external power source to a battery or power supply (not shown) in the housing 110. In some embodiments, the USB device port 134 complies with a USB specification and can include any USB connector.

The memory card port 136 may be constructed as a card slot or the like for removably receiving a micro SD card or related computer memory card for exchanging data with the various electronic components of the microtonal musical instrument interface device 10. The micro SD card (not shown) when inserted in the memory card port 136 can save state information between uses, e.g., musical sessions, and load/save presents, and/or other relevant data. Such data can be stored in a known format such as a Scala file format or the like. The micro SD card is used to store settings from session-to-session, and can save and transfer tuning preset data in a Scala format, but not limited thereto. For example, tunings created in a twelve tone tuning mode can be saved as a preset for subsequent use and processing.

The USB host port 138 is constructed and arranged for coupling the interface device 10 to a USB device such as a MIDI instrument or controller or related peripheral device. In some embodiments, the USB device port 134 is coupled for sending a combination of MIDI data and audio to a computer, such as a personal computer, smartphone, tablet, Raspberry Pi, and so on. In some embodiments, a USB port 134 and/or 138 can function as either a host or a device. Additionally, the USB host port 138 can host a USB hub to host additional MIDI or related devices, up to four in some embodiments, or more in other embodiments

The MIDI DIN input port 140 and MIDI DIN output ports 142 and 144 are constructed and arranged to perform MIDI functions similar to the USB ports 134, 138, respectively, for example, for interfacing the interface device 10 between a keyboard controller controlling a computer and a synthesizer, drum machine, tone generator, or the like. For example, a cable can electrically couple a MIDI output connector of a keyboard to the MIDI input port 140. Another cable can electrically couple the MIDI outputs 142 or 144 to a synthesizer MIDI input In some embodiments, MIDI input, e.g., incoming MIDI notes from a MIDI controller or the like, is via the IN DIN connector 140, the micro USB port 134, or the USB host port 138, and MIDI output can be configured to route or otherwise be output from the DIN output ports 142 and 144, the micro USB port 134, or the USB host port 138 for use with a personal computer or other MIDI instrument.

The various knobs, ports, buttons, etc. are described in FIGS. 2 and 3 as physical elements that can be rotated, pressed, or electrically coupled. In other embodiments, instead of physical knobs, buttons, and so on, some or all of the elements of FIGS. 2 and 3 are icons, graphical display elements or the like that are electronically displayed on a graphical user interface of a computer display and activated by a mouse, finger, stylus, speech command or other computer-based input. In doing so, the microprocessor 150 and/or other circuits in the housing 110 receive data signals from the user interface to perform comparable functions as the physical knobs, ports, buttons, etc. described with respect to FIGS. 2 and 3. In some embodiments, a graphical user interface displaying the knobs, ports, buttons, etc. as icons or other graphical elements communicates with the microprocessor 150 of a microtonal musical instrument interface device similar to that shown in FIGS. 2 and 3, but without some or all of the various LCDs, knobs, etc. as shown in FIGS. 2 and 3.

FIG. 4 is a block diagram of the microtonal musical instrument interface device 10 of FIGS. 2 and 3. In particular, the microprocessor 150 includes inputs and outputs via electronic connection devices to each of the MIDI I/O components via USB and DIN connectors 134-142, micro SD card slot 136, rotary enclosure 118, buttons 120, 122, 124, potentiometers 112, LCD 126, and analog-to-digital converter (ADC) 130. The microprocessor 150 executes computer instructions that permit the microtonal musical instrument interface device 10 to perform tuning operations according to embodiments, for example, described herein. In some embodiments, the microprocessor 150 includes an off-the-shelf computer for performing special-purpose functions regarding the operation of the interface device 10, for example, a 180 MHz ARM Cortex-M4 microprocessor, but not limited thereto. In some embodiments, the micro SD card slot 136, USB device connection 134 and USB host connection 138 are coupled to a Teensy 3.6 development board or the like of the microprocessor 150.

A state of the potentiometers 112, 114, 116 is read by the microprocessors via at least one ADC 130, for example, two 8-channel ADCs. Here, the potentiometers 112, 114, 116 can be configured as voltage dividers and present voltages, respectively, to 14 of the 16 ADC channels. The remaining 2 ADC channels are ignored, or not used. The ADCs 130 digitize the voltages for processing by the microprocessor 150. In some embodiments, the ADC 130 operates at 500K samples per second. In some embodiments, each ADC 130 provides 10 to 16-bit resolution, or greater. The higher resolution, for example, 16-bit, provides for smoother tuning across larger frequency ranges, and also accommodates for MIDI messages used for tuning which use 14-bit values or more. In some embodiments, the LCD 126 communicates with the microprocessor via a shift register, for example, an 8-bit, serial-in, parallel-out shift register or the like. In some embodiments, one or more shift registers between the microprocessor 150 and LCD 126 operates at 3.3V levels at its inputs, and 5V at its outputs, and bridges these two voltage levels for use by the LCD 126, but not limited thereto.

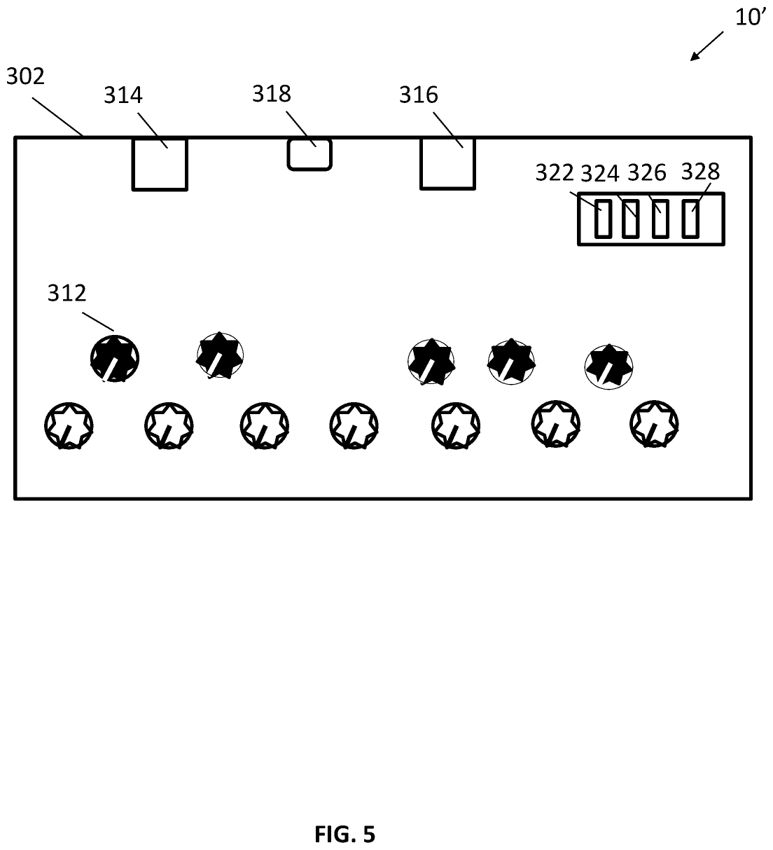

FIG. 5 is a front view of a microtonal musical instrument interface device 10′, in accordance with other embodiments of the inventive concepts. The microtonal musical instrument interface device 10′ performs similar functions as the microtonal musical instrument interface 10 of FIGS. 2-4, except for a different arrangement of knobs, buttons, and ports for operating the interface device 10′. As with the interface device 10 of FIGS. 2-4, the construction, layout, and configuration, e.g., size, of the knobs, buttons, and ports are provided to simplify fine tuning control for a user.

In particular, in some embodiments, positioned on a surface of a housing 302 or related enclosure of a microtonal musical instrument interface device 10′ includes a set of knobs 312 similar to the tuning potentiometer knobs 112 of FIG. 2. For example, a microprocessor 150 shown in FIG. 4 is positioned inside the housing 302 and is constructed and arranged to receive signals from the knobs 312 corresponding to the notes of a twelve-tone scale.

The microtonal musical instrument interface device 10′ also includes an IN DIN connector 314, e.g., a standard 5-pin MIDI input, an OUT DIN connector 316, e.g., a standard 5-pin MIDI output and a micro-USB port 318, similar to those of the microtonal musical instrument interface device 10 of FIGS. 2-4. The IN DIN connector 314 receives and outputs a MIDI input. In some embodiments, the MIDI IN DIN 314 connects a serial input pin on the microprocessor 150 via an optocoupler, which can electrically isolate the MIDI input from the rest of the circuit to prevent ground loops or the like. A MIDI output is user-selectable or automatically selectable by a computer or other electronic switch for output to an external computer or the like from one of the OUT DIN connector 316 and a USB port 318. The output DIN connector 316 can be constructed and arranged to output “tuned” MIDI data to a MIDI instrument (hardware or software) over a standard MIDI cable, and can connect to a serial output pin on the microprocessor 150. In some embodiments, the USB port 318 can be used to input/output MIDI data. In some embodiments, the USB port 318 process a supply power from a power source, for example, to power the interface device 10′.

As shown in FIG. 5, a plurality of two-way switches 322, 324, 326, 328 are selectable between the four following mode options. In FIG. 2, a combination of buttons 118, 120, 122, rotary encoder knob 124, and LCD 126 are used instead of physical switch elements for mode selection.

Switch 322 can be selectable between a polyphonic MIDI instrument or a monophonic MIDI instrument. In particular, when the polyphonic (POLY) mode is selected, MIDI data is output to a polyphonic MIDI instrument. When a monophonic (MONO) mode is selected, MIDI data is output to a monophonic instrument. The main difference is that the monophonic (MONO) mode attempts to retrigger the last note played if more than one key is held down, as is a commonly used keyboard technique in monophonic synthesizer playing.

Switch 324 can be selectable, e.g., toggle, between a USB output vs. a DIN output. In particular, when the USB output is selected, MIDI data is output from the USB port 318. When the DIN output is selected, MIDI data is output on a standard 5-pin MIDI DIN connection 316 or the like.

Switch 326 allows a user to toggle between a pitch blend (PB) or MIDI Tuning Standard (MTS) mode either of which can implement a basic scale mode such as a twelve-tone (12) scale mode or Equal Divisions per Octave (EDO) mode, depending on the type of musical instrument and/or synthesizer supporting MIDI control messages complying with PB and/or MTS mode. The MIDI pitch bend mode is backwards compatible and designed to work with all MIDI synthesizers. Whereas the MIDI Tuning Standard is a more flexible method for tuning microtonally with MIDI but currently only supported by a limited number of modern synthesizers. Switch 328 allows a user to toggle between different basic scale modes such as a twelve-tone scale and EDO modes. Here, when twelve-tone scale mode is selected, all 12 potentiometers 312 may operate as tunable knobs or the like, to tune 12 notes per octave. When EDO mode is selected, only the G# and A# knobs/potentiometers 312 are used to select an n equal divisions per octave scale, where n is between 5 and 53, tuned to a MIDI root note between having a range of 0-127.

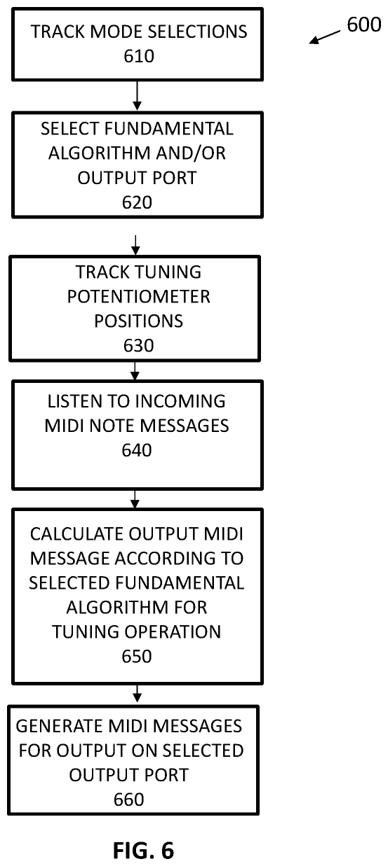

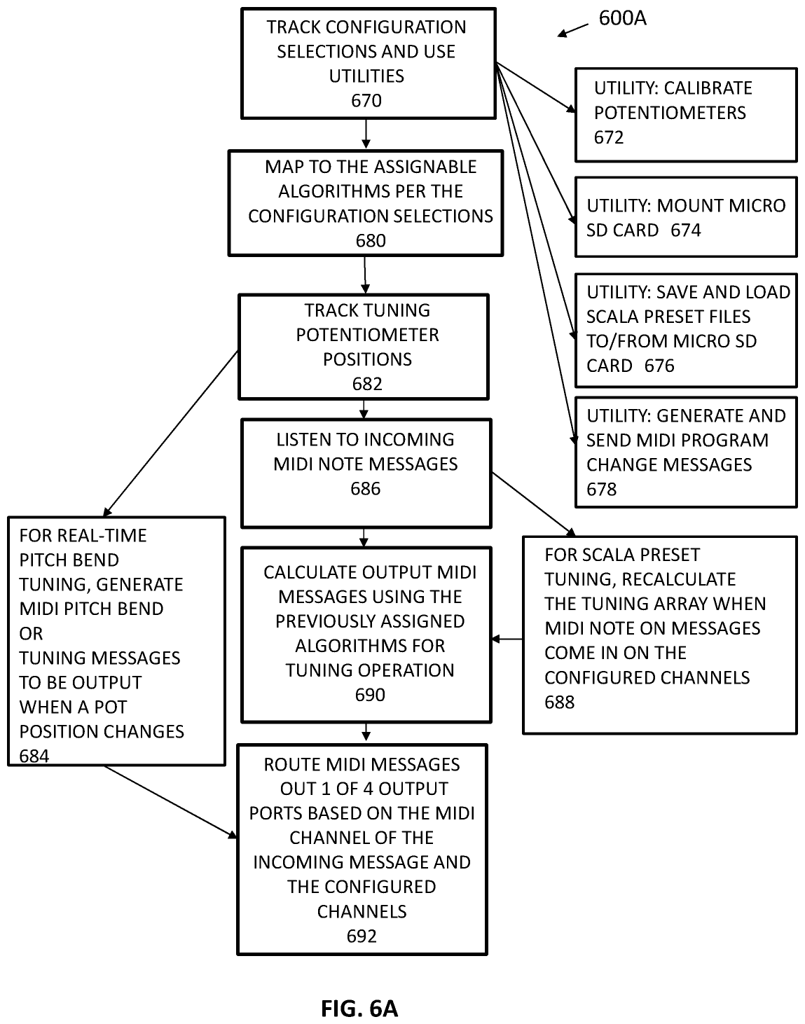

FIG. 6 is a flow diagram of a method 600 of operation of a microtonal musical instrument interface, in accordance with some embodiments of the inventive concepts. Some or all of the method 600 can be performed in the microtonal musical instrument interface device 10 of FIGS. 1-4 or microtonal musical instrument interface device 10′ of FIG. 5. Although interface device 10 is mentioned by way of example, interface device 10′ of FIG. 5 can likewise perform the method 600.

At block 610, mode selections of the mode switches 322, 324, 326, 328 of FIG. 5 or buttons 118, 120, 122 and rotary encoder knob 124 of FIG. 2 are tracked, for example, used to navigate the menu system to change settings and use utilities, described herein with respect to the configuration menu tree.

At block 620, a fundamental algorithm and/or output port is selected that corresponds to the mode selection of block 610. The fundamental algorithm and/or output port can be selected according to the arrangement of 322, 324, 326, 328 of FIG. 4 or buttons 118, 120, 122 and rotary encoder knob 124 of FIG. 2. The selected fundamental algorithm, also referred to herein as an assignable algorithm, calculates the outbound MIDI messages that perform the tuning when output from the interface device 10 to an instrument 104 or the like, which plays the microtuned pitches produced by the microtonal interface device 10, 10′. In some embodiments, a fundamental algorithm can be one of a monophonic twelve-tone using MIDI PB, polyphonic twelve-tone using MIDI PB, monophonic EDO using MIDI PB, polyphonic EDO using MIDI pitch bend, twelve-tone using MTS, or EDO using MTS, Scala preset, number of MIDI channels, monophonic note retrigger priority, real-time pitch bend tuning, and/or next note pitch bend tuning, but not limited thereto. In one embodiment, some or all of these fundamental algorithms are implemented by incorporating some or all of the computing elements of the interface device 10, 10′ described herein, for example, stored in a computer memory and executed by a hardware processor of the interface device 10, 10′.

At block 630, the positions of the tuning potentiometers 112 (FIG. 2) or 312 (FIG. 5) are detected, captured, and stored.

At block 640, the microtonal musical instrument interface device electronically listens for incoming MIDI note messages from the IN DIN connector 140 or a micro-USB port 134 of FIG. 2 or IN DIN connector 314 or USB port 318 of FIG. 5.

At block 650, a calculation is performed on an incoming MIDI note message using the positions of the tuning potentiometers 112 (FIG. 2) or 312 (FIG. 5) and the selected fundamental algorithm.

At block 660, a generated result of the calculation results in one or more MIDI messages that are subsequently output via a selected output port, for example, in response to a USB vs. DIN mode select switch 324 of FIG. 5 or a combination of buttons 118, 120, 122 and display 126 shown in FIG. 2, or automatically determined by a special-purpose processor of the interface device 10.

FIG. 6A is a flow diagram of a method 600A of operation of a microtonal musical instrument interface, in accordance with some embodiments of the inventive concepts. Some or all of the method 600A may include elements of the method 600 of FIG. 6 as well as additional steps.

At block 670, the microtonal musical instrument interface device 10, 10′ includes detection devices, computer processors, and the like for listening for changes to the state of the buttons 118, 122 and the rotary encoder 124. Those states are used to navigate the menu tree displayed on the LCD 126 to make configuration selections and use utilities.

At block 672, the potentiometers 112, 114, 116 are calibrated. The user is instructed to turn every knob fully clockwise and press the Enter button 122 that produces the maximum reading for each potentiometer in this embodiment. The maximum reading can vary between physical units because it depends on the power supply's actual voltage which is within a certain range of the nominal voltage. Each potentiometer is sampled 1,000 times, but not limited thereto so another sampling value may be used, and the lowest maximum reading for each is saved in the EEPROM (non-volatile memory) on board the microprocessor 150. The maximum readings are used in calculations so that the entire physical range of each potentiometer is mapped exactly to the 14-bit number range (0-16383) that is ideal for MIDI pitch bend and MIDI tuning standard messages.

At block 674, a micro SD card can be mounted after the interface device is powered on. The user is instructed to insert a micro SD card and press the Enter button 122. Any error encountered or a successful mount is displayed on the LCD 126.

At block 676, Scala preset files can be saved to a micro SD card in twelve tone tuning mode, and Scala preset files can be loaded from a micro SD card in Scala preset tuning mode.

At block 678, The user selects the output port and MIDI values required: MSB (Most Significant Byte), LSB (Least Significant Byte), and the Program number, and MIDI program change messages for multiple channels can be efficiently sent out to change the program for a connected musical instrument.

At block 680, the fundamental algorithms that corresponds to the configuration selections of block 670 are mapped for use. The fundamental algorithms calculate in real-time the outbound MIDI messages that perform the tuning when output from the interface device 10 to an instrument 104 or the like, which plays the microtuned pitches produced by the microtonal interface device 10, 10′.

In some embodiments, each of the four MIDI output ports 134, 138, 142, 144 has an identical set of fundamental algorithms, and performs the following functions: 1) handle incoming MIDI note on messages, 2) handle incoming MIDI note off messages, 3) handle incoming MIDI pitch bend messages, 4) do real-time tuning versus do next note tuning, 5) handle MIDI messages other than note on, note off, and pitch bend. In order to minimize the processing time and keep the overall controller-to-instrument latency low, the algorithms are highly specific and assigned prior to when incoming MIDI is to be processed.

The fundamental algorithms are mapped based on the following configuration selections: twelve tone tuning versus Scala preset tuning, MIDI pitch bend versus MIDI tuning standard, number of output MIDI channels to use, MIDI tuning standard format with a bank versus without a bank, low note versus high note versus last note monophonic retrigger, pitch bend tuning real-time tuning versus next note tuning.

The fundamental algorithms to handle incoming MIDI note on messages are the following: twelve tone tuning with pitch bend mode for at least twelve MIDI channels, twelve tone tuning for pitch bend mode for less than twelve MIDI channels but more than one, twelve tone tuning for pitch bend mode with only one MIDI channel, Scala preset tuning with pitch bend for more than one MIDI channel, Scala preset tuning with pitch bend for only one MIDI channel, twelve tone tuning with MIDI tuning standard without a specified bank, twelve tone tuning with MIDI tuning standard with a bank, Scala preset tuning with MIDI tuning standard without a specified bank, Scala preset tuning with MIDI tuning standard with a bank. All of the above algorithms generate for output a MIDI note on message. The above algorithms that do “twelve tone tuning” calculate a MIDI pitch bend or tuning value based on the 14-bit values corresponding to the positions of the potentiometers 112, 114, 116. The above algorithms that do “Scala preset tuning” calculate a MIDI pitch bend or tuning value based on values stored in a lookup array that is generated when a new Scala preset file is loaded and whenever the reference tuning note is updated. The above algorithms designated for use “with pitch bend” track the MIDI channel(s) of the note on message(s) so they can later be turned off.

The fundamental algorithms to handle incoming MIDI note off messages are the following: twelve tone tuning with pitch bend mode for at least twelve MIDI channels, twelve tone tuning for pitch bend mode for less than twelve MIDI channels but more than one, twelve tone tuning for pitch bend mode with only one MIDI channel and low note retrigger, twelve tone tuning for pitch bend mode with only one MIDI channel and high note retrigger, twelve tone tuning for pitch bend mode with only one MIDI channel and last note retrigger, Scala preset tuning with pitch bend for more than one MIDI channel, Scala preset tuning with pitch bend for only one MIDI channel and low note retrigger, Scala preset tuning with pitch bend for only one MIDI channel and high note retrigger, Scala preset tuning with pitch bend for only one MIDI channel and last note retrigger, twelve tone tuning with MIDI tuning standard without a specified bank, twelve tone tuning with MIDI tuning standard with a bank, Scala preset tuning with MIDI tuning standard without a specified bank, Scala preset tuning with MIDI tuning standard with a bank. All of the above algorithms generate for output a MIDI note off message. The above algorithms that are “for only one MIDI channel” have an additional step to retrigger any held notes, as this is a common technique used when playing a monophonic musical instrument. The above algorithms designated for use “with pitch bend” use the MIDI channel that was tracked in the assigned MIDI note on algorithm.

The fundamental algorithms to handle incoming MIDI pitch bend messages are the following: tuning with MIDI pitch bend, tuning with MIDI tuning standard. The former algorithm ignores and discards any incoming MIDI pitch bend messages since pitch bend is output to perform the tuning. The latter algorithm simply passes the incoming MIDI pitch bend messages through to the output.

The fundamental algorithms to handle MIDI messages other than note on, note off, and pitch bend are the following: tuning with MIDI pitch bend, tuning with MIDI tuning standard. The former algorithm passes through any incoming MIDI messages to output on all MIDI channels being used. The latter algorithm passes through any incoming MIDI messages to output on the single MIDI channel that is used.

The fundamental algorithms to handle doing real-time tuning versus next note tuning are: tuning in real-time with pitch bend, tuning in real-time with MIDI tuning standard, tuning on the next note. The first algorithm generates for output MIDI pitch bend messages as tuning changes in real time. The second algorithm generates for output MIDI tuning standard messages as tuning change in real time. The last algorithm simply ignores any tuning changes and lets it happen when the next MIDI note on assigned algorithm is called.

At block 682, the positions of the tuning potentiometers 112, 114, 116 (FIG. 2) are detected, captured, and stored.

At block 684, when real-time pitch bend tuning is selected in the configuration at block 610, MIDI pitch bend or MIDI tuning standard messages are generated for output whenever a potentiometer position changes.

At block 686, the microtonal musical instrument interface device 10, 10′ listens for incoming MIDI note messages from the IN DIN connector 140, the micro-USB port 134, the USB host port 138 of FIG. 2.

At block 688, when Scala preset tuning is selected in the configuration and when an incoming MIDI note on message's channel matches the one configured for absolute retuning or the one configured for relative retuning, then the tuning array used in block 650 for Scala preset tuning calculations is updated accordingly. In some embodiments, absolute and relative retuning in a Scala Preset mode where the tuning array is updated in real-time relative to an incoming MIDI note, possibly while using a second MIDI controller in parallel. In some embodiments, one or more dedicated hardware ports for incoming MIDI are used to receive MIDI note on messages intended to be used for absolute or relative retuning, in which case the MIDI channel could be any valid MIDI channel. In some embodiments, one or more buttons, a rotary encoder, a potentiometer, or the like are used to select a reference note or reference frequency used to calculate the values stored in the tuning array.

At block 690, a calculation is performed in real-time on an incoming MIDI messages using the positions of the tuning potentiometers 112, 114, 116 (FIG. 2) and the previously assigned fundamental algorithms. If the message is a note on, then the preassigned fundamental algorithm to handle note on messages is executed. If the message is a note off, then the preassigned fundamental algorithm to handle note off messages is executed. If the message is a pitch bend, then the preassigned fundamental algorithms to handle pitch bend messages is executed; also the preassigned fundamental algorithm to handle real-time tuning versus next note tuning is executed. If the message is another type of MIDI message, then the preassigned fundamental algorithm for other MIDI messages is executed. All of the preassigned fundamental algorithms result in either ignoring/discarding the MIDI or generating MIDI tuning messages to be sent out of one of the four output ports to an instrument.

At block 692, a generated result of the calculation results in one or more MIDI messages that are subsequently output via one of the four output ports: the micro-USB port 134, USB host port 138, output DIN1 connector 140, or output DIN2 connector 144 of FIG. 2. Each output port is configured in block 670 to have a unique input MIDI channel that determines which output port is used for any resulting MIDI messages that are generated for output.

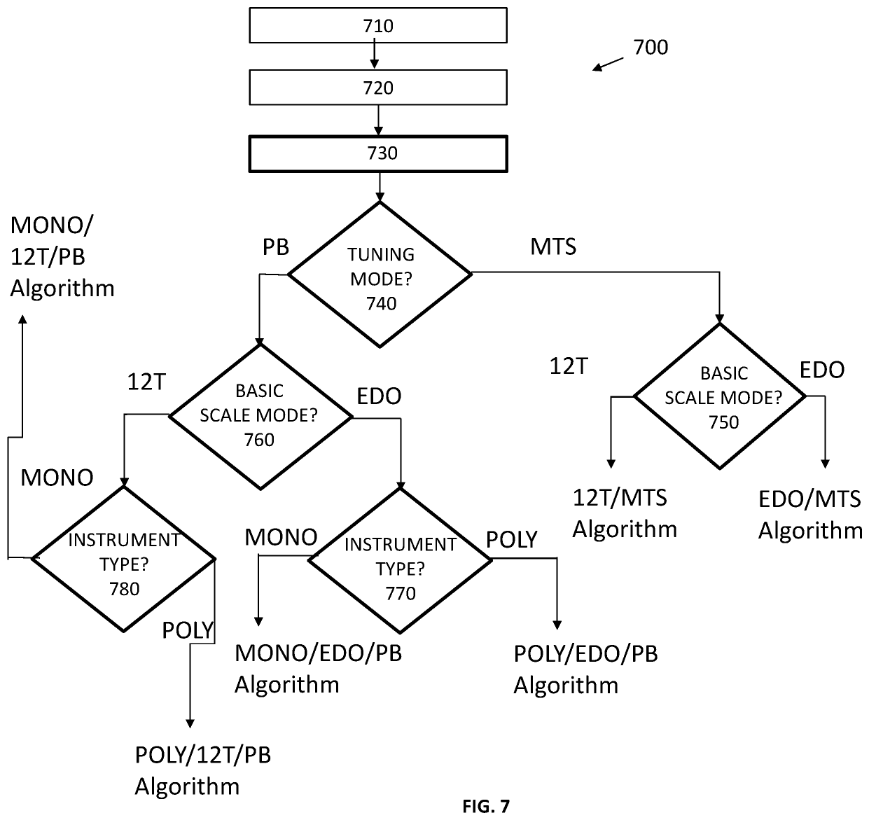

FIG. 7 is a flow diagram of a method 700 for processing MIDI messages, in accordance with some embodiments of the inventive concepts. Some or all of the method 700 can be performed in the microtonal musical instrument interface device 10 of FIGS. 1-4 or microtonal musical instrument interface device 10′ of FIG. 5. Although interface device 10 is mentioned by way of example, interface device 10′ of FIG. 5 can likewise perform the method 600.

At block 710, the positions of the tuning potentiometers 112 (FIG. 2) or 312 (FIG. 5) are tracked, similar to step 630 of FIG. 6. For example, the knob/potentiometer positions are tracked, for example, by the microprocessor 150 and matched to corresponding 14-bit (per the MIDI specification) numerical tuning values. In some embodiments, the ADCs 130 read voltages (0 to +5V nominal) that corresponds to the potentiometer positions 112, 114, 116 (fully counterclockwise to fully clockwise) and linearly map them to 16-bit numbers (0-65535). Those numbers are sent to the microprocessor 150 when it requests them, and it then maps them to 14-bit numbers (0-16383) as are required by the MIDI pitch bend and MIDI tuning standard specifications.

At block 720, data corresponding to the tracked potentiometer positions is stored, for example, in a database, computer memory, or other electronic data storage device.

At block 730, the microtonal musical instrument interface device 10, 10′ listens for incoming MIDI note messages from the IN DIN connector 140 or micro-USB port 134 of FIG. 2 or IN DIN connector 314 or micro-USB port 318 of FIG. 5.

At decision diamond 740, a determination is made whether a selected tuning mode is a PB mode or an MTS mode. If an EDO mode is selected, then the method 700 proceeds to decision diamond 750, wherein a determination is made whether a selected basic scale mode is an EDO mode or a twelve-tone (12T) mode. If at decision diamond 750 the basic scale mode is an EDO mode, then a fundamental algorithm is executed for performing calculations resulting in MIDI messages output from the selected output port in compliance with EDO using MTS.

If at decision diamond 750, the selected basic scale mode is determined to be a 12T mode, then a fundamental algorithm is executed for performing calculations resulting in MIDI messages output from the selected output port in compliance with 12T using MTS.

Returning to decision diamond 740, if a PB mode is selected, then the method 700 proceeds to decision diamond 760, wherein a determination is made whether a basic scale mode is an EDO mode or a twelve-tone (12T) mode. If at decision diamond 760 the basic scale mode is an EDO mode, then the method 700 proceeds to decision diamond 770, where a determination is made whether a selected instrument type is a polyphonic (POLY) MIDI instrument or a monophonic (MONO) MIDI instrument. If at decision diamond 770 the instrument type is determined to be a polyphonic (POLY) MIDI instrument, then a fundamental algorithm is executed for performing calculations resulting in MIDI messages output from the selected output port in compliance with polyphonic EDO using a MIDI pitch bend. Otherwise, a fundamental algorithm is executed for performing calculations resulting in MIDI messages output from the selected output port in compliance with monophonic EDO using a MIDI pitch bend.

Returning to decision diamond 760, if the basic scale mode is determined to be a twelve-tone (12T) mode, then the method 700 proceeds to decision diamond 780, where a determination is made that the basic scale mode is a twelve-tone mode. Here, the method 700 proceeds to decision diamond 780 where a determination is made whether a selected instrument type is a polyphonic (POLY) MIDI instrument or a monophonic (MONO) MIDI instrument. If at decision diamond 780 the instrument type is determined to be a polyphonic (POLY) MIDI instrument, then a fundamental algorithm is executed for performing calculations resulting in MIDI messages output from the selected output port in compliance with polyphonic 12T using a MIDI pitch bend. Otherwise, a fundamental algorithm is executed for performing calculations resulting in MIDI messages output from the selected output port in compliance with monophonic 12T using a MIDI pitch bend. Upon receiving incoming MIDI note messages, the interface device 10 executes exactly 1 of the 6 fundamental algorithms to calculate the appropriate MIDI messages for output.

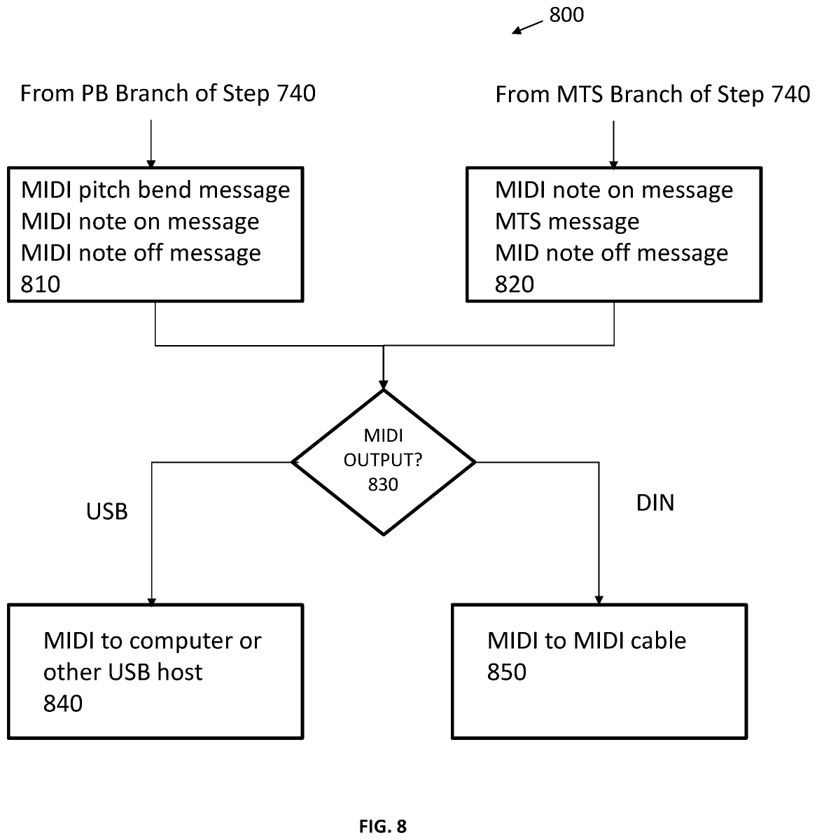

FIG. 8 is a flow diagram of a method 800 for processing MIDI messages, in accordance with some embodiments of the inventive concepts. Some or all of the method 800 can be performed in the microtonal musical instrument interface device 10 of FIGS. 1-4 or microtonal musical instrument interface device 10′ of FIG. 5. Although interface device 10 is mentioned by way of example, interface device 10′ of FIG. 5 can likewise perform the method 600.

As previously described, during operation, the interface device 10 listens for MIDI note messages on an incoming MIDI stream. The knob/potentiometer positions are kept track of and matched to corresponding 14-bit (per the MIDI specification) numerical tuning values. When a note message is received, the interface device 10 generates an outgoing MIDI message that retunes that note according to how the potentiometer knobs or the like are set.

For example, referring again to block 740 of FIG. 7, the pitch blend (PB) branch may include a MIDI pitch blend message, a MIDI note on message, and/or a MIDI note off message. In embodiments where at least one of the monophonic twelve notes per octave MIDI pitch bend mode (MONO/12T/PB), polyphonic twelve notes per octave MIDI pitch bend mode (POLY/12T/PB), monophonic n-equal divisions per octave MIDI pitch bend mode (MONO/EDO/PB), or polyphonic n-equal divisions per octave MIDI pitch bend mode (POLY/EDO/PB) fundamental algorithms are executed, at block 810, a MIDI “pitch bend” message is sent immediately followed by a MIDI “note on” message. This results in the pitch being “bent” and held before the note sounds on the MIDI instrument 104. Every MIDI “note on” message received is translated in real time to an outgoing MIDI “pitch bend” and “note on” pair.

A major complication is that certain versions of the MIDI protocol, in particular, versions prior to v2.0, “pitch bend” messages are channel-wide messages (in MIDI v1.0, the current version used in commercial products). Usually only a single channel of MIDI is used at a time, so then pitch bend affects all the notes sounding. In the case of MONO/12T/TB, POLY/12T/PB, MONO/EDO/PB, POLY/EDO/PB fundamental algorithms, in addition to “retuning the MIDI stream,” the algorithms also juggle the notes that are being held on by distributing them over the 16 available MIDI channels. For example, playing a C-major triad thru the microtonal musical instrument interface device results in the 3 MIDI “pitch bend” and “note on” pairs being played over 3 different MIDI channels so that each of the 3 notes can have their own independent pitch bend. In MIDI v2.0, pitch bend messages can be generated on a per note basis, so using multiple channels is not necessary, which can simplify the microtuning algorithms. Accordingly, the interface device 10, 10′ can operate according to the MIDI v2.0 specification, or related operating protocols such as OSC, but not limited thereto.

For a monophonic twelve notes per octave MIDI pitch bend mode (MONO/12T/PB) algorithm, the device listens for all incoming MIDI notes and outputs corresponding MIDI notes and pitch bends on the first channel. All 12 tuning potentiometers are used to calculate the MIDI pitch bend and note. The MIDI pitch bend is output followed by the MIDI note on. A MIDI note off is sent when various notes are turned off. Only one pitch bend value per live MIDI channel is output. The last note is retriggered if more than one note is held when another is released.

The POLY/12T/PB algorithm is similar to the MONO/12T/PB algorithm, except that there is no retrigger step.

The MONO/EDO/PB algorithm is similar to the MONO/12T/PB algorithm except that only the G#/Ab and A#/Bb potentiometers are used, in some embodiments, to calculate the MIDI pitch bend and note. This results in 49 EDO scales between 5-EDO and 53-EDO, tuned to a root note between 0-127. The POLY/EDO/PB algorithm is similar to the MONO/EDO/PB algorithm, except that there is no retrigger step.

Referring again to block 740 of FIG. 7 as well as block 820 of FIG. 8, the MIDI Tuning Standard (MTS) mode branch may include a MIDI note on message, MTS message, and/or a MIDI note off message.

The 12T/MTS algorithm includes the passing of MIDI note messages in an untouched manner. MTS messages are sent if any one or more of the twelve potentiometers have changed since a previous operation. The EDO/MTS algorithm is similar except only the G#/Ab and A#/Bb potentiometers are used.

For the 12T/MTS and EDO/MTS fundamental algorithms, an MTS message is output according to the positions of the knobs/potentiometers and is independent of the MIDI stream incoming to the interface device 10. MTS messages modify the tuning table internal to a MIDI instrument 104 so that the instrument 104 itself plays a microtonal scale without using MIDI “pitch bend” messages. In this case, it is optional that the MIDI controller 102 send messages into the interface device 10. The MTS messages are generated by knob movements on the interface device 10, and they are sent out to the MIDI instrument 104.

At decision diamond 830, a determination is made whether the MIDI messages are output to the instrument 104 via a DIN output port 142 in FIG. 3, e.g., a standard 5-pin MIDI cable or a USB output port

Some or all of the foregoing can be deployed in a computer system that may be included in an apparatus of FIGS. 1-5 and the methods illustrated in FIGS. 6-8 in accordance with the embodiments of the present disclosure. The computer system may generally comprise a processor, an input device coupled to the processor, an output device coupled to the processor, and at least one memory device coupled to the processor via a bus. The bus may provide a communication link between each of the components in computer, and may include any type of transmission link, including electrical, optical, wireless, etc. The processor may perform computations and control the functions of a computer, including executing instructions included in the computer code for the tools and programs capable of implementing a method, in the manner prescribed by one or more elements of the system and methods described in embodiments herein, wherein the instructions of the computer code may be executed by processor via a computer memory device. The computer code may include software or program instructions that may implement one or more algorithms for implementing the methods of providing a result, as described in detail above. The processor executes the computer code.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

As shown above and as will be appreciated by one skilled in the art, aspects of the present invention may take the form of an entirely hardware embodiment, but is not limited thereto. For example, aspects may take the form of a special-purpose computer that includes an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Therefore, in some embodiments, the microtonal musical instrument interface device's functionality is implemented in software with virtual sliders. In some embodiments, the systems and methods herein include a musical apparatus tuning scheme that could be implemented without using MIDI. For example, hardware and/or software may be implemented as part of a keyboard synthesizer, for instance, where the tuning is performed internally without the need for MIDI.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A microtonal musical instrument interface device between one or more Musical Instrument Digital Interface (MIDI) controllers and one or more musical instruments, comprising:
a housing;
a plurality of potentiometers on a surface of the housing, the potentiometers comprising:
twelve tuning potentiometers constructed and arranged to correspond to notes of a musical scale, each tuning knob for tuning one of the notes;
an offset potentiometer for globally tuning all of the notes by a same amount; and
a range potentiometer for setting a maximum tuning range of the tuning potentiometers; and
a microprocessor in the housing that modifies a MIDI data stream received from one or more MIDI controllers for output to one or more musical instruments according to a position of the potentiometers.

2. The microtonal musical instrument interface device of claim 1, further comprising a plurality of converters that map keys or other tone-producing elements of the musical instrument to notes or microtonal pitches according to the Musical Instrument Digital Interface (MIDI) technical standard.

3. The microtonal musical instrument interface device of claim 1, further comprising at least one communication port that receives messages of the MIDI data stream, and wherein the at least one communication port includes a serial input Deutsches Institut für Normung (DIN) connector, a Universal Serial Bus (USB) device input connector, or a USB host input connector.

4. The microtonal musical instrument interface device of claim 1, further comprising at least one communication port that outputs MIDI messages of the modified MIDI data stream, and wherein the at least one communication port includes a serial output DIN connector, USB device output connector, or USB host output connector.

5. The microtonal musical instrument interface device of claim 1, wherein positions of the plurality of potentiometers are monitored and kept track of and matched to corresponding numerical tuning values, and wherein when a MIDI message that comprises a note is received, the microprocessor generates at least one outgoing MIDI message that comprises a tuned note response to the positions of the potentiometers.

6. The microtonal musical instrument interface device of claim 1, wherein positions of the plurality of potentiometers are monitored, tracked, and matched to corresponding numerical tuning values, and wherein when a position of at least one potentiometer changes, the microprocessor generates at least one outgoing MIDI message that modifies the tuning of a connected musical instrument in response to the positions of the potentiometers.

7. The microtonal musical instrument interface device of claim 1, further comprising a memory device that stores computer program code, a tuning array or other suitable data structure, and a reference note or frequency, wherein the tuning array comprises numerical tuning values relative to the reference note or frequency and for each and every note to be retuned, wherein the tuning array is used for calculations to generate tuned MIDI output.

8. The microtonal musical instrument interface device of claim 1, wherein when a MIDI message comprising a note is received on a pre-configured MIDI channel, the microprocessor replaces a reference note with the received MIDI note and recalculates the tuning array relative to it.

9. The microtonal musical instrument interface device of claim 1, wherein when a MIDI message comprising a note is received on a pre-configured MIDI channel, the microprocessor replaces the reference note with the tuned note resulting from the received MIDI note and recalculates the tuning array relative to it.

10. The microtonal musical instrument interface device of claim 1, wherein a pre-configured MIDI channel distinguishes the notes for tuning from notes intended to trigger a tuned MIDI output of the MIDI data stream.

11. The microtonal musical instrument interface device of claim 1, wherein a MIDI message comprising a note is received on a dedicated hardware input port for tuning from notes intended to trigger a tuned MIDI output of the MIDI data stream.

12. The microtonal musical instrument interface device of claim 1, further comprising a memory device that stores computer program code of at least one fundamental algorithm, and a hardware processor that executes the computer program code of the at least one fundamental algorithm stored in the memory device.

13. The microtonal musical instrument interface device of claim 12, wherein at least one fundamental algorithm calculates outbound MIDI messages from the MIDI data stream to perform a tuning operation.

14. The microtonal musical instrument interface device of claim 12, wherein the fundamental algorithms are executed according to a combination of modes including polyphonic, monophonic, twelve-tone, Equal Divisions per Octave (EDO), Pitch bend, MIDI Tuning Standard (MTS) modes, Scala preset, number of MIDI channels, monophonic note retrigger priority, real-time pitch bend tuning, and next note pitch bend tuning.

15. The microtonal musical instrument interface device of claim 1, wherein the potentiometers further include a reference note potentiometer for setting a reference MIDI note.

16. The microtonal musical instrument interface device of claim 1, wherein the potentiometers further include a divisions per octave potentiometer for setting the number of equal divisions per octave.

17. A microtonal musical instrument interface device, comprising:
a special-purpose microprocessor that modifies a MIDI data stream received from one or more MIDI controllers for output to one or more musical instruments and The microtonal musical instrument interface device of claim 1, wherein when a MIDI message comprising a note is received on a pre-configured MIDI channel or dedicated hardware input port, the microprocessor replaces the reference note with the received MIDI note and recalculates the tuning array relative to it; and
a memory device that stores computer program code, a tuning array or other suitable data structure, and a reference note or frequency, wherein the tuning array comprises numerical tuning values relative to the reference note or frequency and for each and every note to be retuned, wherein the tuning array is used for calculations to generate tuned MIDI output, wherein when a MIDI message comprising a note is received on the pre-configured MIDI channel or dedicated hardware input port, the microprocessor replaces the reference note with the tuned note resulting from the received MIDI note and recalculates the tuning array relative to it.

18. The microtonal musical instrument interface device of claim 17, wherein when a MIDI message comprising a note is received on a pre-configured MIDI channel, the microprocessor replaces a reference note with the received MIDI note and recalculates the tuning array relative to it.
